(19) United States
(12) Patent Application Publication
(10) Pub. No.: US 2007/0006823 A1
(43) Pub. Date: Jan. 11, 2007

(54) Animal safety collar with automatic tension control copyright

(76) Inventor: Michael John Sandberg, Flagler Beach, FL (US)

Correspondence Address: FRANK B. ARENAS, P. O. BOX 600, 2327 TAYLOR AVENUE, COLEMAN, FL, 33521, US

(21) Appl. No.: 11/174,841

(22) Filed: Jul. 5, 2005

(51) Int. Cl. A01K 27/00

(52) U.S. Cl. 119/856

(57) ABSTRACT

An apparatus (device) and system, an animal safety collar, is disclosed; safety collar with built-in emergency leash and automatic tension control or (in alternative embodiments) an animal safety collar to remotely track and communicate with a loose animal that has broken its primary leash and has roamed to an unknown distant location. Also disclosed is an accessory pouch disposed on the collar and at least one item placed in or on said accessory pouch selected from the group consisting of battery, solar photovoltaic cell, video camera, audio microphone, Global Positioning Satellite device, radio frequency identification chip, video recorder, audio recorder, cell phone, information card/chip/microfiche, radio, remote-activated clicker, peripheral components and other user-defined means for and types of communication, identification and tracking. The device may also be used as a primary leash/collar for animals.

### COPYRIGHT NOTICE

A portion of the disclosure of this patent document, including Appendices, contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### BACKGROUND OF THE INVENTION

1. Field of the Invention.

The present invention relates generally to collars used for training, control and restraint of animals, such as dogs, cats, etc. The invention particularly relates to an animal safety collar with built-in emergency leash with an automatic tension control (ATC) to humanely control animals in the event of primary leash failure to reduce the chances of a loose animal (the ATC may also be used as a primary leash system). The invention also more particularly relates (in alternative embodiments) to an animal safety collar to remotely track and communicate with a loose animal that has broken its primary leash and has roamed to an unknown distant location.

2. Description of the Prior Art.

U.S. Pat. No. 6,367,428 discloses a combination dog collar and leash system.

U.S. Pat. No. 5,497,733 discloses an animal control, training apparatus and method of use.

U.S. Pat. No. D359,598 discloses an ornamental design for a combined collar and handle.

None of the cited prior art discloses or teaches a back-up safety collar with built-in emergency leash or (in alternative embodiments) to an animal safety collar to remotely track and communicate with a loose animal that has broken its primary leash and has roamed to an unknown location. Further, none disclose the new and useful feature of the present invention of the Automatic Tension Control (ATC) that is a hybrid of a fixed-diameter collar and a choker-collar. The ATC gives the operator all of the advantages of a fixed-diameter collar while giving more controlled tightness when needed to control the animal via the collar without the disadvantages of a conventional choker-collar that can injure an animal (potentially crush a windpipe) if pulled too tightly.

### SUMMARY OF THE INVENTION

It is an object of the invention to act as a built-in emergency leash to control animals in the event of primary leash failure to reduce the chances of a loose animal. It is another object of the invention to give the operator all of the advantages of a fixed-diameter collar while giving more controlled tightness when needed to control the animal via the collar without the disadvantages of a conventional choker-collar that can injure an animal (potentially crush a windpipe) if pulled too tightly. It is another object of the invention (in alternative embodiments) to remotely track and communicate with a loose animal that has broken its primary leash and has roamed to an unknown location.

This new and useful animal safety collar device (“device”) accomplishes these objectives; the objects of this invention are achieved and the present invention provides a new and useful article of manufacture and method for use.

### BRIEF DESCRIPTION OF THE DRAWINGS

FIG. 1 is a side view of the animal safety collar.

FIG. 2 depicts a perspective view of the animal safety collar.

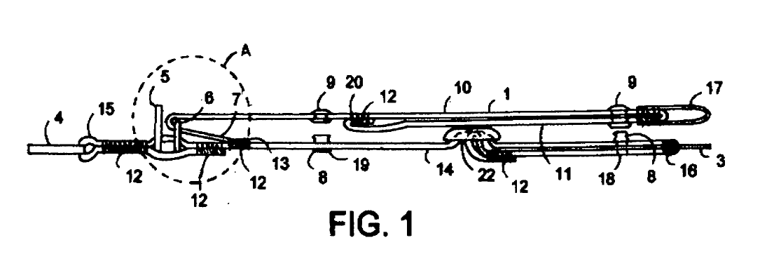

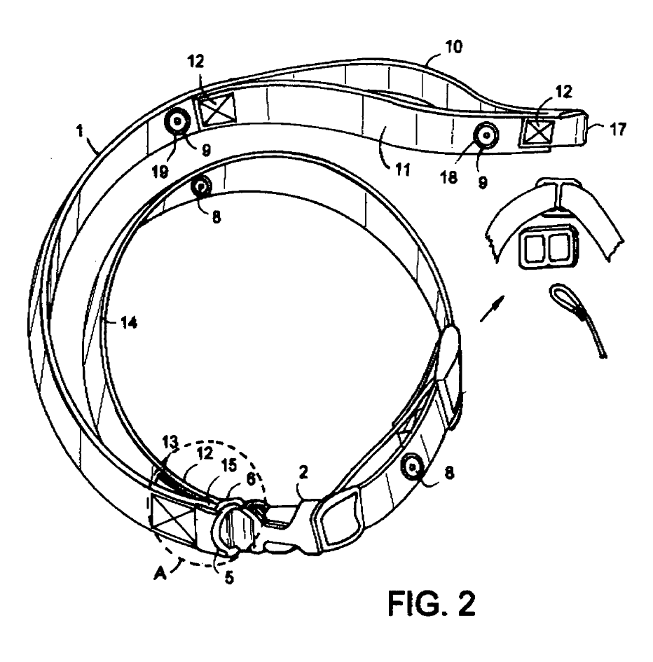

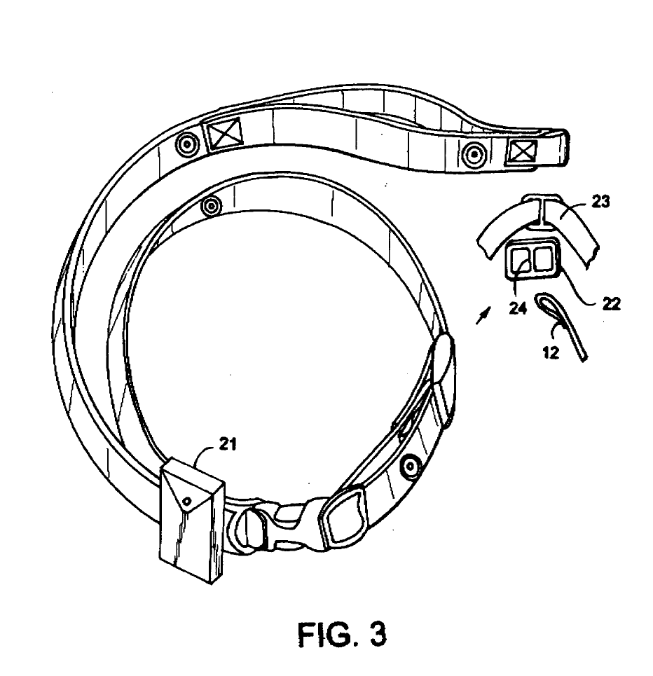

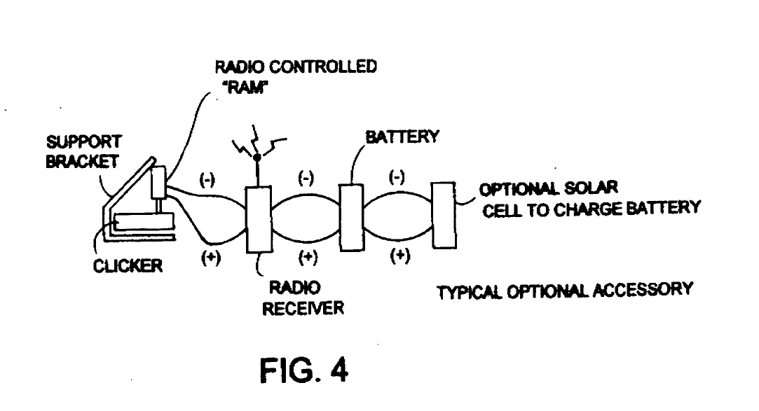

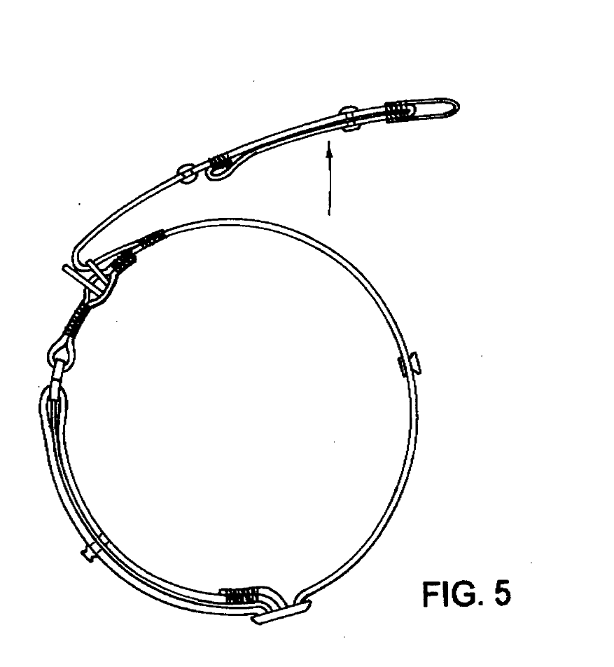

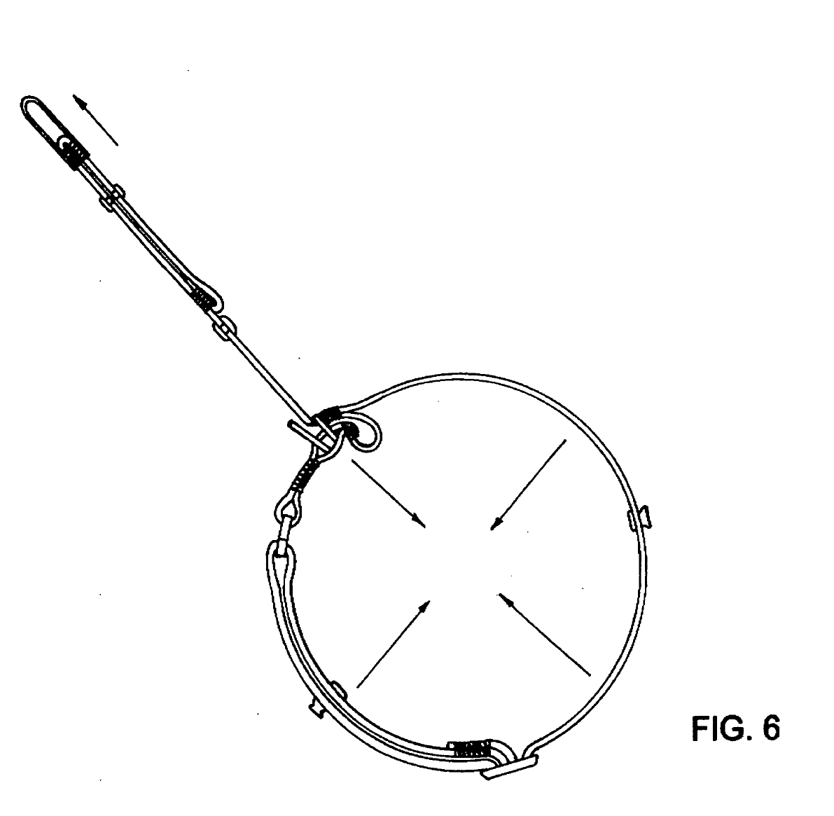

FIG. 1 and FIG. 2 highlight Detail “A” which is the Automatic Tension Control (ATC) feature of the device (with box stitch in hidden view).

FIG. 3 depicts a perspective view of the animal safety collar with accessory pouch (AP).

FIG. 4 depicts a schematic of a typical accessory option to be placed in or on the accessory pouch (“remote clicker” in this example) embodiment of the collar.

FIG. 5 depicts the leash unfastened from the collar by the operator.

FIG. 6 depicts the leash pulled by the operator, placing the leash in tension and using the ATC (Automatic Tension Control) structure to reduce the collar's diameter and increase tightness of the collar around the animal's neck.

### DETAILED DESCRIPTION OF THE PREFERRED EMBODIMENT

The apparatus of the invention is conveniently fabricated by conventional and standard methods using conventional and standard materials common in the animal collar fabrication and electronic industries.

For example, the animal safety collar device (“device”) and components may be fabricated from aluminum, stainless steel or like metals or any other suitable metal material. The device and components may also be fabricated from non-metallic materials for lighter weight and corrosion resistance. Theses non-metallic materials include, among others, conventional polymers such as, for example, polystyrene, polycarbonate, polyurethane, polyethylene, phenol formaldehyde resins, polybutylene, Teflon and the like. The attachment means employed for attaching the device to the primary leash and the electronic elements to the device may be made of any of the above-referenced materials or any type of glue, bolt, snap, fastener, screw, strap, wire, cord, line, rope, rivets or webbing using Dacron, Spectra, nylon, touch-fastener (Velcro) and similar materials, among others. These above-mentioned materials are examples and do not limit the types of materials that can be used to make and use the device; any and all suitable materials may be used. The components of the device may be integrated together by standard means such as sewing, welding, ultrasonic welding, bolting, gluing, riveting, fastening or any other suitable means. This invention is compact and of simple construction that is easy to make and use. In best mode, the device components are sewn and snapped together.

The apparatus and method of using the invention will now be further described and exemplified by reference to the various specific embodiments set forth in the drawings. FIG. 1, FIG. 2 and FIG. 3 are views of the preferred embodiment of the invention.

Again referring to all 3 Figures, the assembly and fabrication of the preferred embodiment of the invention will be described in detail. The device is assembled and fabricated from standard materials and methods now used in the appropriate industries.

The device is typically fabricated from nylon webbing and sewing. The attachment components may be fabricated from steel (or stainless steel), machined using conventional machine-shop and metal fabrication techniques such as drilling, cutting, smoothing, welding, bolting, polishing, sandblasting and painting. The device is shown with its design, functional aspects and relationship of components in scalable form in all of the drawings combined.

Now the method of making the device in the preferred embodiment and best mode will be described in detail. Referring to all of the drawings, first, suitable nylon webbing is selected and cut to an appropriate length. The overall length of the collar will vary between fourteen (14) and twenty-four (24) inches, but may be any length. The materials used in construction are: Webbing 1 of one (1) inch in width, the hardware to secure the collar around the animal's neck is a one (1) inch wide “side release” fastener 2 (with a male part 3 and female part 4 which connect/disconnect, usually plastic, flat or curved, and are well known in the industry). A one (1) inch “welded metal D ring” 5 for use when a separate primary leash is being attached, and a one (1) inch “rectangular welded metal ring” 6 to route the built in emergency leash to the collar assembly and allow the Automatic Tension Control (ATC) 7 to function when needed. Two (2) metal snaps (comprising a male snap 8 and female snap 9) to secure the emergency leash when not in use. The ATC 7 allows the advantages of a choker collar (well known in the industry) to hold the animal in check combined with the advantages of a constant diameter collar that reduces the potential for injury to the animal. Injury to the animal is the main disadvantage of the choker collar of the prior art. Automatic tension control is hereby defined as a structure (for example, lever, pulley, ratchet and all other structure types that accomplish the same effect) integrated into the collar at the leash attachment point such that when the leash is slack, the collar is a constant diameter and has appropriate tightness around the animal's neck, while if the leash is pulled with force by the operator and put in tension, the collar's diameter is reduced via the automatic tension control a sufficient amount to tighten around the animal's neck to increase control yet not enough to injure the animal.

The following typical construction points will remain the same on all collars (fixed or adjustable diameter) and emergency leashes:

The emergency leash has a handle 10 at one end that consists of about seven (7) inches of webbing folded back upon itself 11. A three-quarter (¾) inch (typical) “Box X” stitch 12 is sewn at the very end of the fold. This leaves a seven (7) inch piece of webbing folded back upon itself (10 & 11). One (1) inch of webbing at the very end is folded back underneath 20 and is stitched with a “Box X” stitch 12 creating a five (5) inch long loop for the emergency leash handle (10 & 11). The collar end 13 of the emergency leash handle is routed through a (1) inch “rectangular welded metal ring” 6 sewn into the collar 14 and is fastened to the collar 14 by securing it with a “Box X” stitch 12 to the collar 14 about one (1) inch. Two female metal snaps 9 will be fastened to the emergency leash assembly. One female snap 9 is at the end of the emergency leash handle (3\4″) three-quarters of an inch from the very end in the “Box X” stitch 12 leaving a small tab 17 of webbing at the very end. The other female snap 9 will be about half-way between either end of the emergency leash. This distance will vary depending on the finished length of the emergency leash\collar assembly.

This completes the emergency leash assembly and allows a one (1) inch Automatic Tension Control (ATC) 7 as previously described. The ATC “slack” 7 typically will be about one-half (½) inch to four (4) inches, depending on the size of the animal's neck. The ATC slack 7 may be from more than zero (0) inches and up to as many inches as needed to provide sufficient tightening force on the animal as needed.

The collar is constructed of a suitable length of typical webbing by threading about five (5) inches of the typical webbing through the female part 4 of the “side release” fastener 2 and folded back approximately two (2) inches back upon itself and then sewn in place with a “Box X” stitch 12 on the primary leash attach end 15. This leaves a three (3) inch flap of webbing. Then the one (1) inch “welded metal D Ring” 5 is threaded through the three (3) inch flap first and then the “rectangular welded metal ring” 6 is threaded through the three (3) inch flap second. Then a “Box X” stitch 12 secures the “welded metal D Ring” 5 and the “rectangular welded metal ring” 6 to the collar. As shown on FIGS. 1, 2 and 3, on the adjustable end 16 of the collar, the webbing is threaded 23 through the adjustable slide 22 and through the male part 3 of the “side release” fastener 2 and folded back on itself about five (5) inches and sewn to the middle post 24 of the adjustable slide 22 and secured with a “Box X” stitch 12. The adjustable slide 22 allows the collar to be adjusted smaller or larger diameter for the exact dimensions of the animal's neck.

The emergency leash, when attached as described above, will now pivot on the “rectangular welded metal ring” 6 on the collar 14 with about one (1) inch of ATC 7 slack for use if needed. On the collar two male snaps 8 will be fastened in positions on the collar so the emergency leash will be able to be fastened securely collar when the emergency leash is not in use. When the emergency leash\collar is fastened around the pet's neck via the “side release” fastener 2, the emergency leash will lay flat and around the animals neck secured by the two (2) metal snaps (comprising a male snap 8 and female snap 9). As shown in FIGS. 5 and 6, by pulling on the small tab at the end of the leash the first snap 18 can be released exposing the emergency leash handle. By pulling the emergency leash farther the second snap 19 will release and the emergency leash will pivot on the collar at the “rectangular welded metal ring” 6 connected to the collar and allow the operator to employ the ATC 7 if needed. By reversing this procedure the emergency leash can be securely fastened back to the collar. A separate primary leash system [not included] may be used with the collar utilizing the “welded D ring” 5 attached the collar. The collar may be removed from the animal via the “side release” fastener 2 in the customary manner.

Essentially, in one embodiment, (best mode) the animal safety collar, comprises at least one flexible strap of suitable length, width and thickness having at least one releasable fastener disposed on at least one end of said strap to form a releasable collar when wrapped around an animal's neck in a substantially loop shape of suitable diameter and fastened, and;

further comprises at least one weld metal D ring disposed on said collar, and at least one leash further comprising a flexible strap of suitable length, width and thickness with a handle end and a collar end, and;

further comprises said collar end of said leash routed though the opening of at least one rectangular welded metal ring disposed on the collar and the collar end of the leash attached to the collar at a predetermined distance from the rectangular welded metal ring entry opening, and;

the handle end of the leash folded over the top of the rectangular welded metal ring disposed on the collar and back onto the collar in the opposite direction from entry of the collar end of the leash into the rectangular welded metal ring, and;

further comprises at least one releasable snap fastener further comprising a female part and a male part, and;

further comprises the male part of the snap fastener disposed on the collar and the female part of the snap fastener disposed on the leash, and;

the leash fastened to the collar by mating the male and female parts of the snap fastener such that when the handle end of the leash pulled upwardly with force by the operator, the snap fastener releases and when the operator pulls upwardly with more force on the handle end of the leash, the leash is put in tension using the rectangular welded metal ring as a lever to pull on the collar at the leash attachment point thereby reducing the diameter of the collar and tightening the restraint around the animal's neck.

Other embodiments of the device include custom colors, designs, logos, advertising, seasonal symbols (such as Christmas, Halloween and New Year's Eve), decorative artwork, embroidery, stripes, letters, reflective tape for more visibility and safety at night and other embellishments integrated onto any part of or location on the device.

Another embodiment of the device, as shown in FIG. 3, involves an accessory pouch (AP) 21. The AP 21 is made typically from nylon cloth and typically sewn together with an operable top flap typically about the size of a cigarette pack (but may any size needed for the intended purpose). This pouch may be attached to the device in many alternate ways; glue, bolt, snap, fastener, screw, strap, wire, cord, line, rope, rivets, sewn or webbing using Dacron, Spectra, nylon, touch-fastener (Velcro) and similar materials. This pouch is used to contain various components for communication, identification and/or tracking the animal if the primary leash is broken and the animal wanders to an unknown location. Such components may include a battery and/or solar photovoltaic (PV) power source, video camera, audio microphone, GPS (Global Positioning Satellite) transmitter, RFID (radio frequency identification) chip, video and/or audio recorders (either self-contained or wireless to a remote receiver), cell phone, information card/chip/microfiche (for contact information for the animal owner or special instructions for the animal, such as medical information, for example), radio (transmit only, receive only or two-way transmit/receive), remote-activated clicker (used in clicker training with some animals, such as dogs) and necessary peripheral components and other means for and types of communication, identification and tracking. (All owner's manuals, specifications, user's manuals, documentation installation manuals and all related documents of the specific products mention below (for illustrative purposes only) are hereby adopted and incorporated by reference).

For instance, the AP may contain a clicker (typically like those offered for sale at Clicker Company, PO Box 93515, Phoenix, Ariz. 85070; Phone: 480-706-1884 Fax: 480-706-1883, Email: Info@CiickerCompany.com; www.clickercompany.com) coupled with a radio remotely-activated solenoid (“ram” common in the radio-controlled miniature aircraft industry for flight controls) and power source (typically a battery) and remote transmitter that can click the remote clicker to trigger the stimulus-response to a trained animal. FIG. 4 depicts a schematic of this embodiment.

The AP may contain a GPS tracking chip (such as those offered by KCS BV, Kuipershaven 22, 3311 AL Dordrecht, The Netherlands, Fax: +31 (0)78 6312659 or Fax2: +31 (0)20 5248130, www.gprs.tv) and other necessary components such as power source (battery) and peripherals well known to one skilled in the art, may be used to track the animal remotely.

The AP may contain a RFID (radio frequency identification) chip/system (such as those offered by Precision Dynamics Corporation, 13880 Del Sur Street, San Fernando, Calif. 91340-3490 USA, E-mail: info@pdc-rfid.com, Fax: 818.686.9315, www.pdcorp.com or IBM Corp., at www.ibm.com, IBM Corporation, 1133 Westchester Avenue, White Plains, N.Y. 10604, United States) and other necessary components such as power source (battery) and peripherals well known to one skilled in the art, may be used to track the animal remotely.

The AP may contain a remote wireless video camera (such as those offered by www.x10.com, 1-800-675-3044, (253) 437-3800, 19823 58^{th} Place South, Kent, Wash., 98032 or www.seemorewildlife.com, SeeMore Wildlife Systems, 127 E Bunnell, Homer, AK 99603, (907) 235-1492, sales@seemorewildlife.com) and other necessary components such as power source (battery) and peripherals well known to one skilled in the art, may be used to track the animal remotely or use the animal for reconnaissance in law enforcement, military or recreational uses.

The AP may contain a radio (receive only, transmit only or both transmit/receive) or walkie-talkies (such as those offered by Cobra Electronics Corporation 6500 West Cortland Street, Chicago, Ill. 60707, www.cobraelectronics.com, such as the “MicroTalk”) and other necessary components such as power source (battery) and peripherals well known to one skilled in the art, for communication with the animal via spoken words, sounds, clicks (for clicker trained animals as mentioned above) or to injured persons found by the trained animal by fire rescue or the military, for example.

The AP may contain a cell phone (such as those offered by Nokia at www.nokia.com, Nokia Head Office, Keilalahdentie 2-4, P.O. Box 226, FIN-00045 Nokia Group, Finland Tel. +358 (0) 7180 08000) and other necessary components such as power source (battery) and peripherals well known to one skilled in the art, to communicate with the animal via ring tones or automatic answer of incoming calls for voice or to injured persons found by the trained animal by fire rescue or the military, for example.

The AP may utilize a solar cell (or photovoltaic cell(s), such as those offered by Real Goods, Inc., www.realgoods.com, 13771 S. Highway 101 Hopland, Calif. 95449 Highway 101, just ½ mile south of Hopland, ph. 707/744-2100 fax 707/744-1342) and other necessary components such as power source (battery) and peripherals well known to one skilled in the art, for charging any power system (batteries) for electronics used with the device, enabling an sustainable power source for an indefinite time, if needed.

As will be apparent to persons skilled in the art, such as designer, animal collar manufacturer, electronics engineer/designer and those in related fields, various modifications and adaptations of the structure and method of use above-described will become readily apparent without departure from the spirit and scope of the invention, the scope of which is defined in the claims. Although the foregoing invention has been described in detail by way of illustration and example, it will be understood that the present invention is not limited to the particular description and specific embodiments described but may comprise any combination of the above elements and variations thereof, many of which will be obvious to those skilled in the art. Additionally, the acts and actions of fabricating, assembling, using, and maintaining the preferred embodiment of this invention is well known by those skilled in the art. Instead, the invention is limited and defined solely by the following claims.

The invention may be embodied in other specific forms without departing from the spirit or essential characteristics thereof. The present embodiment is therefore to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed is:

1. An apparatus, an animal safety collar, comprising:
at least one flexible strap of suitable length, width and thickness having at least one releasable fastener disposed on at least one end of said strap to form a releasable collar when wrapped around an animal's neck in a substantially loop shape of suitable diameter and fastened, and;
at least one leash further comprising a flexible strap of suitable length, width and thickness attached to said collar, and;
further comprising a means for providing an automatic tension control structure integrated into the collar at the leash attachment point such that when the leash is slack, the collar is a constant diameter and has appropriate tightness around the animal's neck, while if the leash is pulled with force by the operator and put in tension, the collar's diameter is reduced via the automatic tension control structure a sufficient amount to tighten around the animal's neck to increase control yet not enough to injure the animal.

2. The animal safety collar of claim 1 wherein the means for providing automatic tension control structure further comprises said leash routed through at least one rectangular welded metal ring disposed on said collar and said leash attached to said collar about one half inch to about four inches from said rectangular welded metal ring.

3. The animal safety collar of claim 1 wherein said collar is adjustable either longer or shorter to adjust the diameter as needed.

4. The animal safety collar of claim 1 wherein said leash is releasably attached to the outside surface of the circumference of said collar.

5. The animal safety collar of claim 1 further comprising at least one welded D ring disposed on said collar for use with a second leash connected therein if desired.

6. The animal safety collar of claim 1 further comprising ornamentations thereon selected from the group consisting of custom colors, designs, logos, advertising, seasonal symbols, decorative artwork, embroidery, stripes, letters, reflective tape and other user-defined ornamentations.

7. The animal safety collar of claim 1 further comprising at least one accessory pouch disposed thereon.

8. The animal safety collar of claim 7 further comprising at least one item placed in or on said accessory pouch selected from the group consisting of battery, solar photovoltaic cell, video camera, audio microphone, Global Positioning Satellite device, radio frequency identification chip, video recorder, audio recorder, cell phone, information card/chip/microfiche, radio, remote-activated clicker, peripheral components and other user-defined means for and types of communication, identification and tracking.

9. An apparatus, an animal safety collar, comprising:
at least one flexible strap of suitable length, width and thickness having at least one releasable fastener disposed on at least one end of said strap to form a releasable collar when wrapped around an animal's neck in a substantially loop shape of suitable diameter and fastened, and;
at least one accessory pouch disposed thereon.

10. The animal safety collar of claim 9 further comprising at least one item placed in or on said accessory pouch selected from the group consisting of battery, solar photovoltaic cell, video camera, audio microphone, Global Positioning Satellite device, radio frequency identification chip, video recorder, audio recorder, cell phone, information card/chip/microfiche, radio, remote-activated clicker, peripheral components and other user-defined means for and types of communication, identification and tracking.

11. The animal safety collar of claim 9 wherein said collar is adjustable either longer or shorter to adjust the diameter as needed.

12. The animal safety collar of claim 9 further comprising ornamentations thereon selected from the group consisting of custom colors, designs, logos, advertising, seasonal symbols, decorative artwork, embroidery, stripes, letters, reflective tape and other user-defined ornamentations.

13. The animal safety collar of claim 9 further comprising at least one welded D ring disposed on said collar for use with a second leash connected therein if desired.

14. A system, an animal safety collar, comprising:
at least one flexible strap of suitable length, width and thickness having at least one releasable fastener disposed on at least one end of said strap to form a releasable collar when wrapped around an animal's neck in a substantially loop shape of suitable diameter and fastened, and;
further comprising at least one weld metal D ring and at least one rectangular welded metal ring disposed on said collar, and
further comprising at least one leash further comprising at least one flexible strap of suitable length, width and thickness with a handle end and a collar end, and;
further comprising said collar end of said leash routed though the opening of the rectangular welded metal ring disposed on the collar and the collar end of the leash attached to the collar at a predetermined distance from the rectangular welded metal ring entry opening, and;
the handle end of the leash folded over the top of the rectangular welded metal ring disposed on the collar and back onto the collar in the opposite direction from entry of the collar end of the leash into the rectangular welded metal ring, and;
further comprising at least one releasable snap fastener further comprising a female part and a male part, and;
further comprising the male part of the snap fastener disposed on the collar and the female part of the snap fastener disposed on the leash, and;
the leash fastened to the collar by mating the male and female parts of the snap fastener such that when the handle end of the leash is pulled upwardly with force by the operator, the snap fastener releases and when the operator pulls upwardly with more force on the handle end of the leash, the leash is put in tension using the rectangular welded metal ring as a pulley to pull on the collar at the leash attachment point thereby reducing the diameter of the collar and tightening the restraint around the animal's neck.

15. The animal safety collar system of claim 14 wherein said collar is adjustable either longer or shorter to adjust the diameter as needed.

16. The animal safety collar system of claim 14 further comprising ornamentations thereon selected from the group consisting of custom colors, designs, logos, advertising, seasonal symbols, decorative artwork, embroidery, stripes, letters, reflective tape and other user-defined ornamentations.

17. The animal safety collar system of claim 14 further comprising at least one accessory pouch disposed thereon.

18. The animal safety collar system of claim 17 further comprising at least one item placed in or on said accessory pouch selected from the group consisting of battery, solar photovoltaic cell, video camera, audio microphone, Global Positioning Satellite device, radio frequency identification chip, video recorder, audio recorder, cell phone, information card/chip/microfiche, radio, remote-activated clicker, peripheral components and other user-defined means for and types of communication, identification and tracking.

19. The animal safety collar system of claim 14 further comprising a welded D ring disposed on said collar for use with a second leash connected therein if desired.
